(19) United States
(12) Patent Application Publication
(10) Pub. No.: US 2003/0229758 A1
(43) Pub. Date: Dec. 11, 2003

(54) Magnetic disk device

(75) Inventor: Masakazu Kawamoto, Kawasaki (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 10/353,581

(22) Filed: Jan. 29, 2003

(30) Foreign Application Priority Data
Jun. 11, 2002 (JP) 2002-170311

(51) Int. Cl. G06F 12/00

(52) U.S. Cl. 711/114; 711/113

(57) ABSTRACT

A magnetic disk sub-system composed of a plurality of magnetic disk drives comprises a rotation synchronizing control circuit, where the rotations of the spindle motors of a plurality of magnetic disk drives are synchronized. By distributing/allocating a data position to a different address on each drive, rotations can be synchronized, and if the data is read from a head, the concurrence of a plurality of segments of data transfer can be prevented by shifting the timing in which the data is actually read from each disk.

### BACKGROUND OF THE INVENTION

1. Field of the Invention

The present invention relates to a magnetic disk device in a data storage medium, such as a magnetic disk and related media.

2. Description of the Related Art

FIGS. 1 and 2 show the configurations of a conventional magnetic disk sub-system.

In FIGS. 1 and 2, reference numbers 1 and 2 represent a magnetic disk drive and an HBA (host bus adaptor) or RAID controller, respectively.

FIG. 1 shows the configuration of a RAID (redundant array of inexpensive disks) system adopting a SCSI (small computer system interface) as its protocol. A host is a PC (personal computer) or a workstation (WS), and it comprises a CPU, memory (MEM), a CPU bus, an LSI, an I/O bus and the like. A SCSI HBA is connected to this host through a PCI-BUS, and the host can control magnetic disk drives 1. Each magnetic disk drive 1 is connected to the host through a SCSI BUS, and it transmits/receives data to/from the host under the control of the SCSI HBA. As an option, the system can further comprise a SPIN-SYN unit synchronizing the rotations of magnetic drives. This function can synchronize the rotations of the spindle motors for reading each magnetic drive medium.

FIG. 2 shows the configuration of a RAID system adopting FC-AL (Fiber Channel Arbitrated Loop) as its protocol. Since the configuration of a host is the same as for a RAID system, it is omitted in FIG. 2. In this case, an FC-AL HBA forms a loop path between the host and each magnetic disk drive 1. In the case of the FC-AL, the rotations of the spindle motors of the magnetic disk drives can be synchronized using a “MARK” primitive signal.

However, a conventional magnetic disk device adopting a SCSI or an FC-AL does not use a rotation synchronizing mechanism at the time of normal operation. In this case, each magnetic disk drive independently rotates and arbitrarily transfers data, depending on the positions of the storage medium and its read/write head. Therefore, each disk has its own number of rotations. Since the respective number of rotations of the disks differ a little from one another, a plurality of magnetic disk devices gradually rotate sometimes synchronously and sometimes asynchronously.

A method for synchronizing the rotations of a plurality of disks and simultaneously transferring data is already known. This synchronization method has one of the configurations shown in FIGS. 1 and 2, and is called a level-3 RAID system. High-speed data reading/writing required by the entire system can be realized by synchronizing the rotations of a plurality of magnetic disks and by reading/writing data in parallel. In this case, however, since the data path between each magnetic disk and the main memory of the host system must have a transfer capability sufficient to realize parallel data transfer in its design stage, such a system becomes very expensive.

In a magnetic disk sub-system other than a level-3 RAID system, each disk usually rotates independently. In such a device, main memory is connected to a data path between each magnetic disk and a process program through the data buffer of the magnetic disk, and through an interface connecting a magnetic disk and a host system and an internal bus, such as the PCI of the host system. Therefore, unless all these devices meet a specific data transfer capability, data transfer is restricted and the interface becomes a bottleneck for data transfer.

In a specific system configuration, if a magnetic disk is extended because of an increase in the volume of data which causes a corresponding increase in the capacity of the system and if there is an increase in the number of disks connected to the same interface, the interface becomes the bottleneck of the system interface even when there is no bottleneck in the data transfer. However, if the number of interfaces is increased to avoid this bottleneck, then a data transfer bottleneck will occur because the transfer capability of the internal bus, connecting the interface and memory in which data is finally stored in the host system, cannot handle the increased processing needed for supporting multiple interfaces.

There is a simple and inexpensive system, such as Serial ATA (SATA), which has been developed assuming that the nearest host and its magnetic disk drive are connected one-to-one. If a RAID system is organized using SATA, then each device independently controls the rotation of its own magnetic disk drive and as a result, the respective numbers of rotations of the devices will slightly differ from one another. Therefore, in a system composed of a plurality of disks, such as a RAID system, a situation can occur where sometimes data is simultaneously transferred and sometimes no data is transferred.

However, in the case of a SCSI or an FC-AL, if, in an interface to which a plurality of disks is connected, there is a collision of data transfer requests between disks, then the data transfer will be conducted within the range of the transfer capability of the interface. This can be done by selecting the disk, in which data transfer is being conducted, and by occupying/controlling the interface, and suppressing the data transfer of the other disks, it an be ensured that the plurality of disks does not simultaneously transmit data.

FIG. 3 shows the popular configuration of a magnetic disk sub-system. FIG. 4 is a timing diagram showing the transfer timing in the case of a SCSI or an FC-AL.

As shown in FIG. 3, in the magnetic disk sub-system, a magnetic disk drive 1 and a magnetic disk controller 2 are connected by a magnetic disk interface 7, which is the interface for these devices. The magnetic disk controller 2 is connected to a buffer 3 through an internal bus. Furthermore, the buffer 3 is connected to a PCI bus controller 4. The PCI bus controller 4 is connected to a PCI bus 5, which is connected to the host.

Since as shown in FIG. 4, a magnetic disk is a rotating medium, data can be transferred only when the positions of the medium and its utilized head match. In this case, an interface cannot always be used. Therefore, as shown in FIG. 4, when drive a is transferring data, drive b cannot transfer data even if it can access the data of the medium at the same timing reference point. Therefore, a buffer temporarily storing data is provided for each magnetic disk and when the interface becomes free, data is transmitted/received between the buffer and the host. In other words, in order to allow a shift in the positions of the medium and data transfer in terms of time, the data is temporarily stored in the buffer.

In the case of a small buffer capacity, if the same size data as the buffer capacity is being transferred in succession, then the medium and the head must be re-synchronized in order to read/write data. In this case, a rotation waiting time is needed and performance degrades. Since in order to prevent this, a larger-capacity buffer must be used, the cost of the device increases.

If only one magnetic disk is connected to an interface in a configuration in which the memory of a host and a disk is connected one-to-one, such as in SATA, there is no waiting time needed for interface usage. However, in this case, a plurality of segments of data transfer can center on the part of the system where a plurality of interfaces and the memory are connected. Thus, if all of the drives simultaneously request a data transfer, then there will be a data transfer bottleneck possibility. Because priority-based processing of data is carried out, processing of segments of data transfer at the transfer center means there is suppression of interfaces that can be used for data transfer. In effect, it means disks must wait for interface usage.

### SUMMARY OF THE INVENTION

It is an object of the present invention to provide a magnetic disk device composed of a plurality of disk drives each with a small buffer capacity that can solve the bottleneck of data transfer.

A magnetic disk device according to the present invention is composed of a plurality of magnetic disk drives. The magnetic disk device comprises a synchronizing means for synchronizing the rotations of the motors of the plurality of magnetic disk drives; and a data storage means for shifting and storing the data storage position of each magnetic disk in such a way as to read data from each magnetic disk at different timings when reading data from the plurality of disks. By reducing the waiting time for reading data from each magnetic disk, the capacity of a buffer possessed by each magnetic disk drive can be reduced, and simultaneously, data can be prevented from being transferred in such a way as to exceed the capacity of a data transmission line.

According to the present invention, since the data reading/waiting time can be reduced by synchronizing the rotations of a plurality of magnetic disk drives and shifting the position of data on each magnetic disk, the capacity of the buffer of each magnetic disk drive can be reduced. Simultaneously, since each piece of data is read at a different timing, data can be efficiently transferred even if the transfer capacity of a data transmission line ranging from the magnetic disk sub-system to the host is small.

### BRIEF DESCRIPTION OF THE DRAWINGS

FIG. 1 shows the configuration of a conventional magnetic disk sub-system (No. 1);

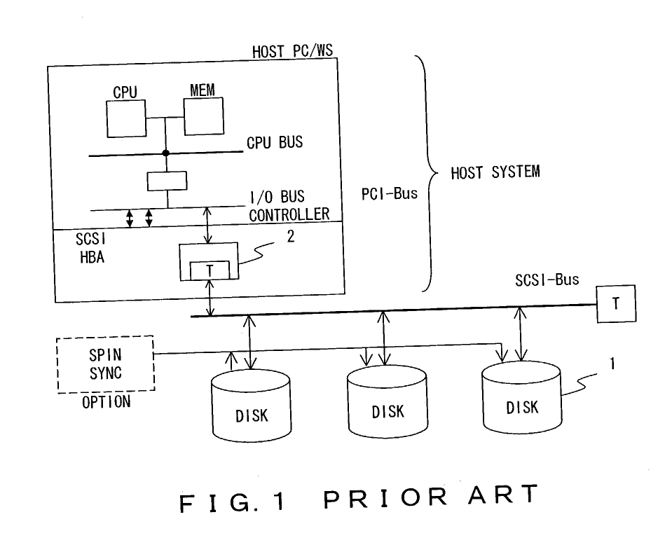

FIG. 2 shows the configuration of a conventional magnetic disk sub-system (No. 2);

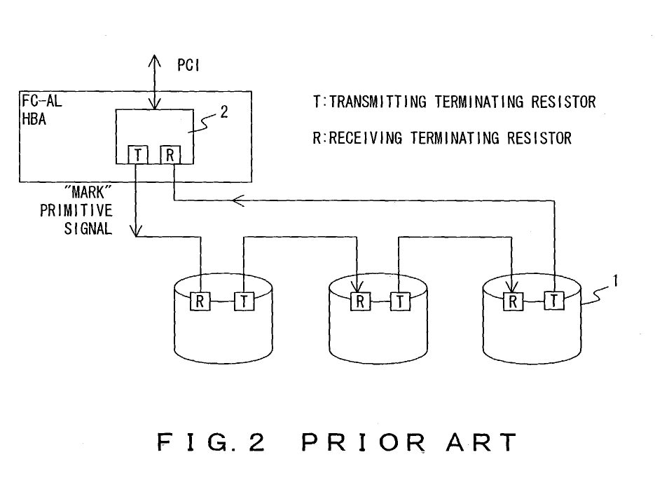

FIG. 3 shows the popular configuration of a magnetic disk sub-system;

FIG. 4 is a timing diagram showing the data transfer timing in the case of a SCSI and an FC-AL;

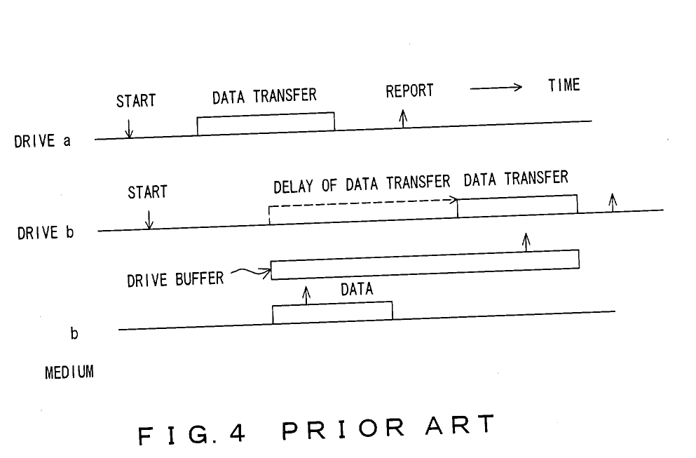

FIG. 5 shows an example configuration of the magnetic disk sub-system in the preferred embodiment of the present invention;

FIG. 6 shows the concept of the preferred embodiment of the present invention;

FIG. 7 is a timing diagram showing the data transfer timing in the preferred embodiment of the present invention;

FIG. 8 shows an example of a rotation synchronizing mechanism;

FIG. 9 shows an example configuration of a servo circuit;

FIG. 10 shows how to synchronize the rotations of a plurality of driving media (No. 1);

FIG. 11 shows how to synchronize the rotations of a plurality of driving media (No. 2);

FIG. 12 shows an example of data layout by the driver software of the medium;

FIG. 13 shows an example of data allocation according to the preferred embodiment;

FIG. 14 shows data transfer conducted when an I/O bus has a two or more simultaneous task transferring capability (No. 1); and

FIG. 15 shows data transfer conducted when an I/O bus has a two or more simultaneous task transferring capability (No. 2).

### DESCRIPTION OF THE PREFERRED EMBODIMENTS

In the preferred embodiment of the present invention, data transfer requests are prevented in advance from simultaneously occurring among a plurality of magnetic disks by synchronizing the rotations of magnetic disk drives and shifting the data position on each drive medium of each device using a magnetic disk control device.

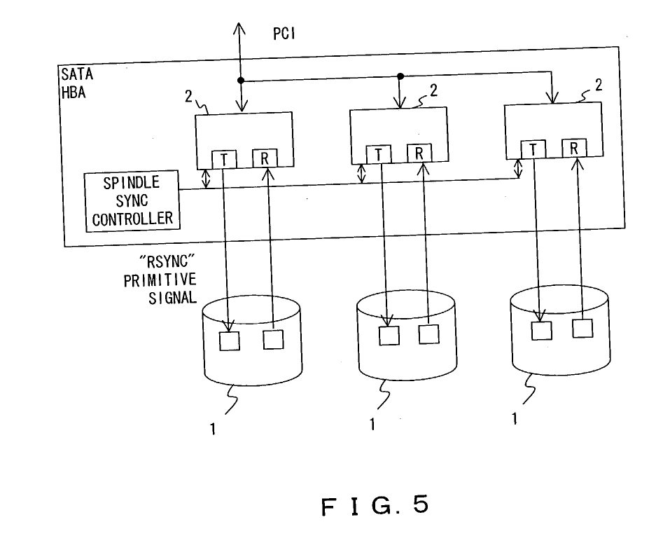

FIG. 5 shows an example configuration of a magnetic disk sub-system in the preferred embodiment according to the present invention.

In FIG. 5, the host is omitted.

In this preferred embodiment, a RAID system is organized using SATA. Therefore, a SATA HBA comprises the same number of magnetic disk controllers 2 as that of connected magnetic disk drives. Each magnetic disk controller 2 controls its own magnetic disk drive 1. In this preferred embodiment, a signal for synchronizing the rotations of the magnetic drives 1 (“RSYNC” primitive signal) is exchanged between each magnetic disk drive 1 and a corresponding magnetic disk controller 2. A rotation synchronizing control circuit (spindle sync controller) newly provided for this preferred embodiment generates an “RSYNC” primitive signal. The “RSYNC” primitive signal is then inserted between data signals based on SATA between the magnetic disk controller 2 and the magnetic disk drive 1, and is exchanged between the magnetic disk controller 2 and the magnetic disk drive 1.

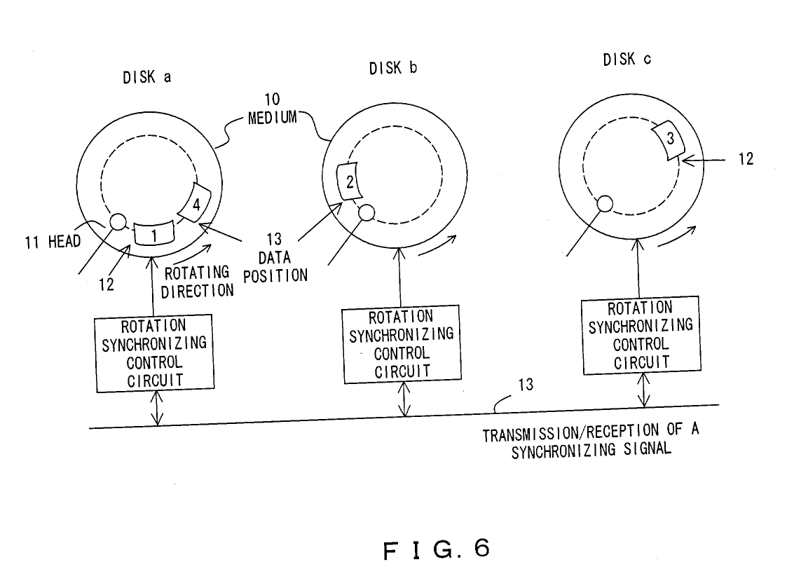

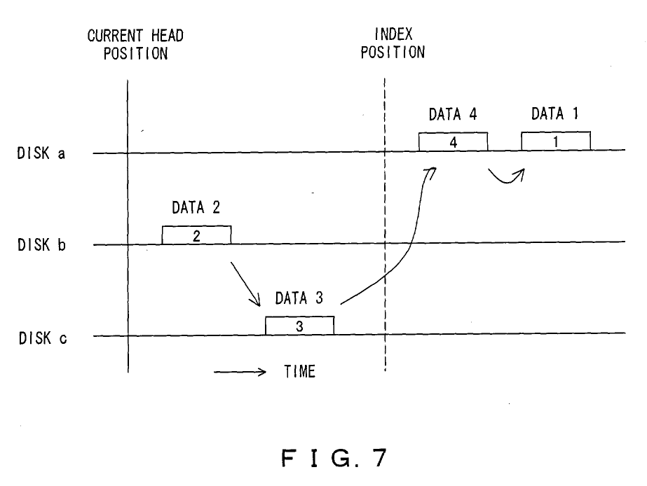

FIG. 6 shows the concept of the preferred embodiment of the present invention. FIG. 7 is a timing diagram showing the data transfer timing in the preferred embodiment of the present invention.

In FIG. 6, reference numbers 11, 12 and 13 represent a medium, a head, a data position on the medium and the transmission/reception of a synchronizing signal, respectively. As shown in FIG. 6, the rotation synchronizing control circuit (although in FIG. 6, there is described a plurality of rotation synchronizing control circuits, in reality, only one rotation synchronizing control circuit is sufficient for the entire medium) supplies a synchronizing signal to each of the respective spindle motor driving circuits of disks a through c, enabling the rotations of these motors to be synchronized. Therefore, the respective heads 11 of the disks a through c access the same address of the respective disks a through c at the same timing reference point. In this preferred embodiment, the respective data positions (data storage addresses) of the disks a through c are different. For example, in FIG. 6, in disk a, data are stored in addresses 1 and 4. In disks b and c, data is stored in addresses 2 and 3, respectively. Therefore, as shown in FIG. 7, the respective timings transferred from the disks a through c are different and there is no data transfer collision. This is because timings, in which the disks a through c rotate and where there are the data read by corresponding heads, are different if the rotations are synchronized and the respective data positions are different.

In this way, the size of the transfer buffer of each magnetic disk can be reduced and data stagnation due to insufficient data transfer capability is prevented from occurring in all the data paths leading from the magnetic disk device to the maim memory of the host. In this way, performance can be improved without increased cost by canceling the line re-synchronizing process needed by data stagnation.

As described above, the conventional bottleneck problem of a data path can be solved.

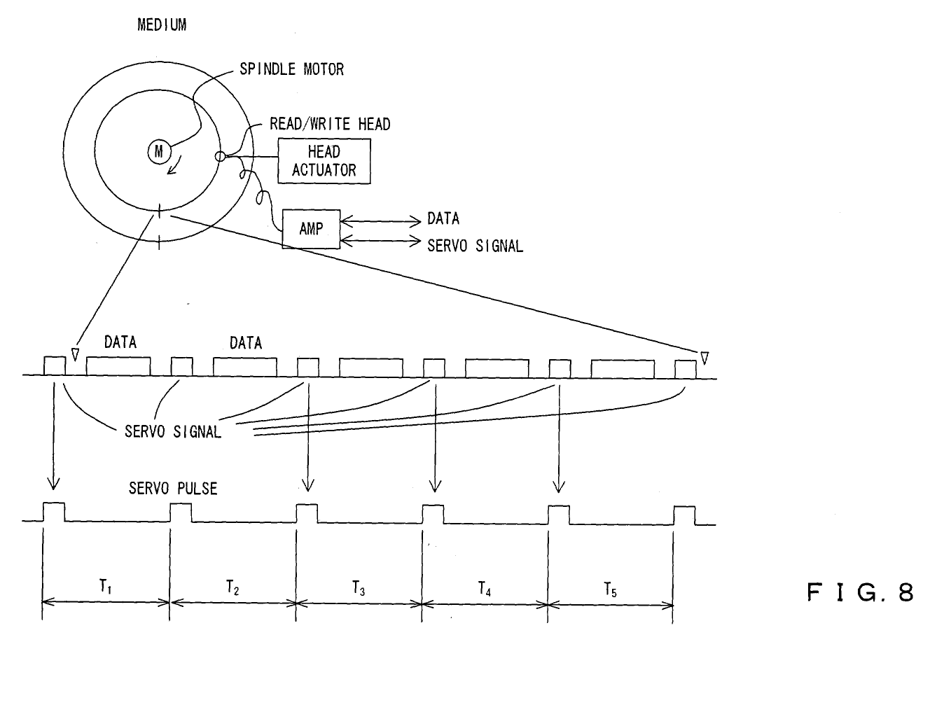

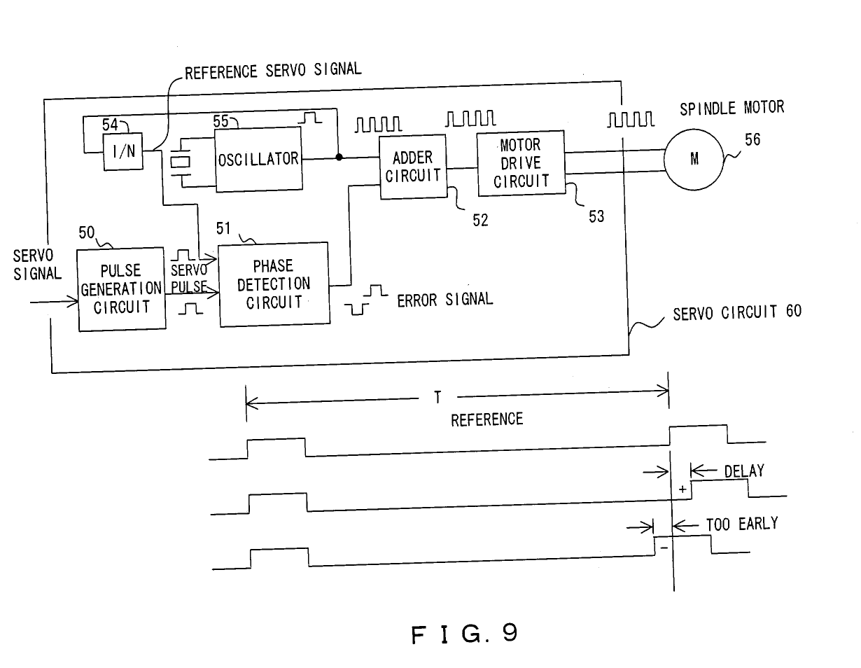

FIG. 8 shows an example of a rotation synchronizing mechanism. FIG. 9 shows an example configuration of a servo circuit.

As shown in FIG. 8, in order to maintain the rotation of each disk medium constant, a servo signal is inserted between data signals on the medium at specific intervals and a rotation error is detected by reading this servo signal. The number of rotations of each servomotor is adjusted based on this error. In this way, rotation deviation due to windage loss caused by the position change of the head or its head arm, and the like, can be removed to maintain the rotation of the medium constant. Each of symbols T1 through T5 shown in FIG. 8 represents the time interval between servo pulses. Each spindle motor is controlled in such a way as to maintain these values constant. A head actuator drives the read/write head. After being amplified by an amplifier, AMP, a servo signal read from the head is transmitted to the servo circuit, which is described later. Similarly, after being read, data recorded on the medium is amplified by the amplifier, AMP, and is transmitted to the read/write circuit, which is not shown in FIG. 8.

If a servo signal recorded on the medium is read from the read/write head and is input to a servo circuit 60 (FIG. 9), the pulse generation circuit 50 of the servo circuit 60 converts the extracted servo signal into a pulse, and a phase detection circuit 51 compares the pulse with the pulse of a reference oscillator 55. A motor driving circuit 53 rotates a spindle motor 56 using a pulse oscillated at specific intervals by the reference oscillator 55, and mechanical rotation deviation is detected as a pulse phase difference by comparing a reference servo pulse signal obtained by dividing this pulse, by a frequency divider circuit 54, with the generated servo/pulse based on the actual servo signal.

The phase detecting circuit 51 transmits a rotation error signal to an adder circuit 52. Based on the error signal, if the rotation delays, the adder circuit 52 increases the number of rotations of each motor by shortening the time interval of the motor driving pulse from the oscillator 55, and if the rotation is too fast, it decreases the number of the rotations of each motor by widening the time.

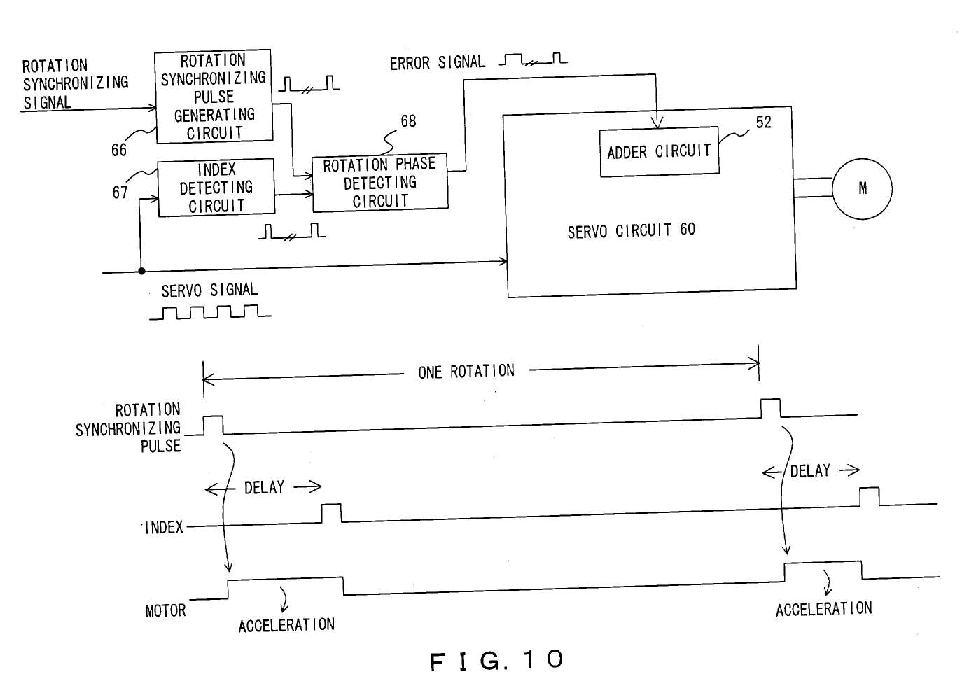

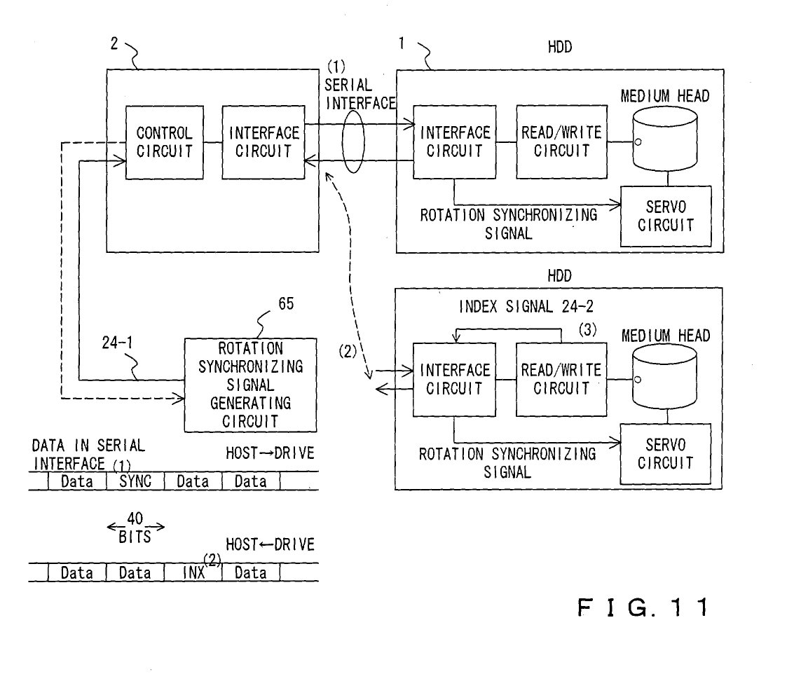

FIGS. 11 and 10 show how to synchronize the rotations of a plurality of drive media. A rotation synchronizing signal, which is the basis of rotation synchronization, can be generated by the reference oscillator of a rotation synchronizing signal generation circuit 65 (24-1). Alternatively, one drive is selected from a plurality of drives and the index signal of this selected drive can be used (24-2). In either case, this rotation synchronizing signal is inserted between data signals and is transmitted, as shown in the lower section of FIG. 11. Each magnetic disk drive comprises a rotation synchronizing pulse generator circuit 66 (see FIG. 10) supplying the rotation synchronizing signal to each drive as one 40-bit primitive signal in the case of serial interface. Even when the rotation synchronizing signal is lost for some reason, this circuit 66 continues to generate a rotation synchronizing pulse at specific intervals. When a rotation synchronizing signal arrives externally again, the circuit 66 synchronizes the generation of a rotation synchronizing pulse with the arrival of the rotation synchronizing signal. However, each drive comprises an index detecting circuit 67 detecting an index, which indicates the start point of a rotation, in the servo signal. The rotation phase detecting circuit 68 of each driver detects the time difference between the rotation synchronizing pulse and index pulse, and generates an error signal. This error signal is added to the adder circuit 52 of the servo circuit 60, and accelerates the rotation of each motor. As the number of rotations of the motor increases, an error between the rotation synchronizing pulse and index pulse decreases. When the rotations are synchronized, the rotation of the motor is accelerated no more.

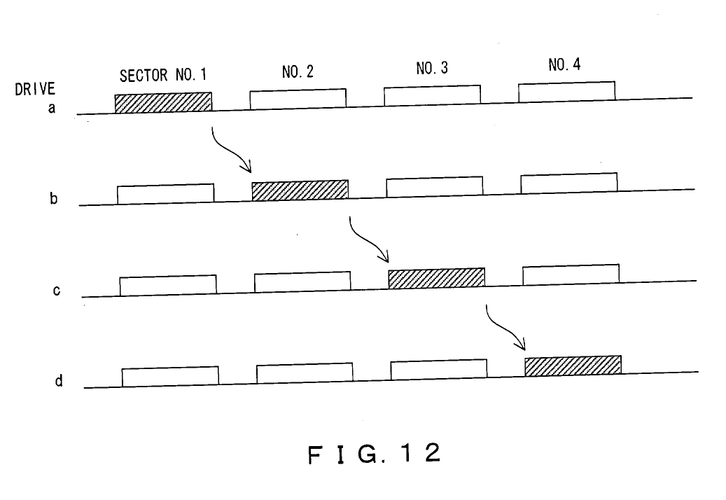

FIG. 12 shows an example of data layout by the driver software on the medium.

On an HDD, a specific number of sectors for recording a fixed length of data are allocated to tracks. If there are four sectors, an index is allocated to the head and after that, the addresses of the sectors No. 1 through No. 4 are arranged in that order. The driver software is a program for reading and writing data, as in the following, in order to allocate data.

In the case where data for four sectors are written into four drives, the program is as follows:

write drive a sector No. 1

write drive b sector No. 2

write drive c sector No. 3

write drive d sector No. 4

In the case where data for four sectors are read from four drives, the program is as follow:

read drive a sector No. 1

read drive b sector No. 2

read drive c sector No. 3

read drive d sector No. 4

In this case, “read” or “write” is a command, and each of “drive N” and “sector M” represents the data position (address) in which a command is executed.

Usually, in each drive, processes are not always performed in the order in which commands are issued.

In this preferred embodiment of the present invention, since the rotations of drivers are synchronized and as shown above in FIG. 12, where each sector is shifted one and is designated, the processes are performed in the order in which commands are issued.

According to this data layout method, data is sequentially allocated to a different drive in order to distribute load among drives. For example, if one drive is used in succession, data is allocated to the relevant drive. If there is data for another task in the same drive, the data processes for two tasks will center on this one drive. If the total amount of the two data processes exceeds the capacity of the drive, the data transfer cannot be executed. However, if the total amount of data can be evenly distributed among a plurality of drives, this over-capacity problem can be avoided.

In this preferred embodiment of the present invention, each drive can simultaneously perform a data process on the medium and a data transfer process in the interface. In other words, a buffer for waiting for the rotation of a drive is not needed. Since buffer memory is expensive and a standard interface can be used without modification, the cost of a drive can be reduced.

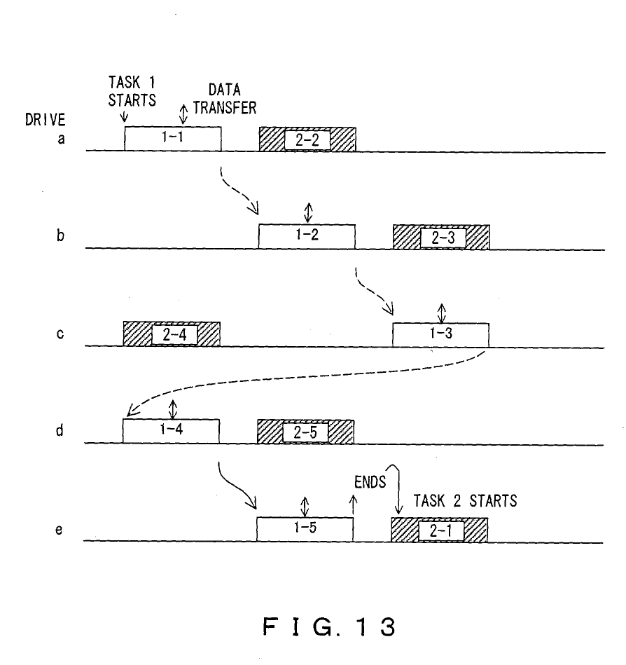

FIG. 13 shows an example of data allocation according to this preferred embodiment.

First, data for task 1 is allocated to drives a through e as a plurality of segments of data 1-1 through 1-5. The size of each segment of data is determined based on the size of the buffer of each drive.

Then, data for task 2 is allocated to drives a through e as a plurality of segments of data 2-1 through 2-5. In this case, if data 2-1 follows data 1-5, data can be transferred without waiting for rotation.

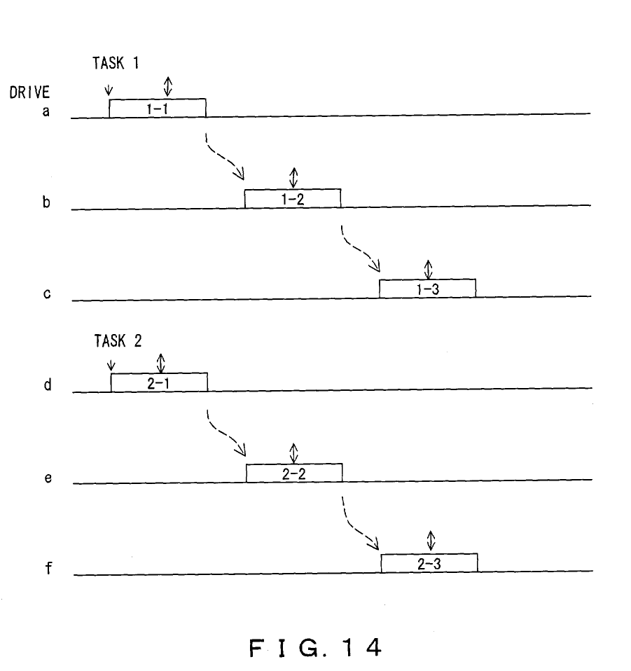

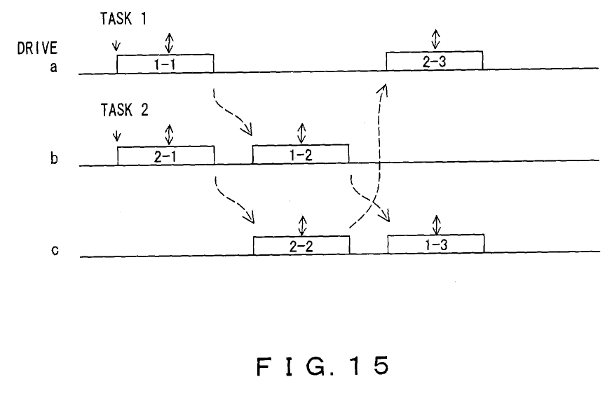

If the data transfer capacity of an I/O bus is occupied by a data transfer in which one task is processed by only one drive, only one task can be processed. However, if the I/O bus has a capacity for data transfer in which two tasks can be processed by two drives, data can be transferred as described in FIGS. 14 and 15.

FIGS. 14 and 15 show how data transfer is conducted when an I/O bus has a two or more simultaneous task data transfer capability.

FIG. 14 shows the case where two tasks are simultaneously processed. As shown in FIG. 14, if there are drives a through f, the drives a through c and drives d through f conduct the respective data transfer of tasks 1 and 2, respectively. In this case, since the I/O bus can simultaneously transfer data for the two tasks, two segments of data from drives a and d, data from drives b and e and data from c and f are simultaneously transferred. However, as described earlier, among the drives a through c and drives d through f, data position and transfer timing must be shifted.

FIG. 15 shows the case where there are three drives and the I/O bus that can simultaneously transfer two tasks. In this case, a plurality of pieces of data 1-1 through 1-3 of task 1 and a plurality of segments of data 2-1 through 2-3 of task 2 can be stored and transferred in the method shown in FIG. 15. As shown in FIG. 15, a plurality of segments of data of the same task do not center on the same drive in order to distribute the load of data transfer among the drives.

This preferred embodiment of the present invention is also applicable to SCSI and FC-AL.

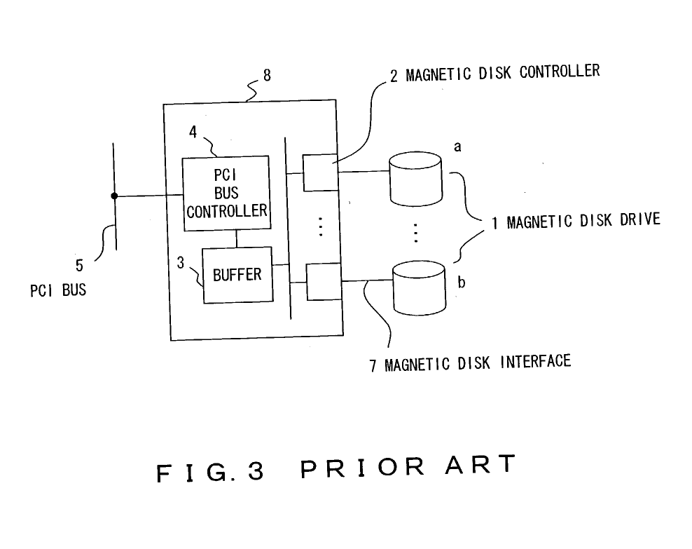

Each of its applications to SCSI and FC-AL is described with reference to FIG. 3.

In FIG. 3, reference numbers 1 and 8 represent a magnetic disk drive and an HBA (host bus adaptor) or RAID controller, respectively. In a SCSI bus method, a synchronizing pulse based on the index of a primary drive is transmitted to the other drives through a SPIN SYNC signal line, which is a different line from the SCSI bus, as a rotation synchronizing signal to synchronize the rotations of the drives by increasing or decreasing the number of rotations of each drive. In FC-AL, similarly, the primary drive transmits a “MARK” primitive signal to the link. Then, the other drives receive this signal and adjust their respective number of rotations. In Serial ATA, a synchronizing pulse is transmitted/received between control chips. An “RSYNC” primitive signal is transmitted/received to/from a serial link with a SATA drive, and the number of the rotations is adjusted based on this. In either case, a synchronizing control signal can also be individually wired instead of using an interface. After the rotations of the drives are synchronized in this way, as described earlier, the data allocation of each drive is shifted.

In this preferred embodiment of the present invention, in order to synchronize the rotations of drives, a rotation synchronizing function and a function to process a synchronizing signal must be added to the drive and host, respectively. Furthermore, driver software must execute data layout. The lack of any of the three factors described above leads to the loss of the function of the present invention. However, in that case, even if rotations are not synchronized or data layout is not executed, there is no lost or garbled data, although waiting due to transfer competition occurs and performance degrades. This is because although the order of access to data becomes random, there is no influence on the data read/write process.

This means that another company's HDD can be incorporated into a system adopting the present invention although performance degrades. In this way, higher performance can be realized compared with the company's existing product despite using an HDD based on the same standards as the company.

According to the present invention, by controlling the timing occurrence of a data transfer request of a magnetic disk, a data transfer function, to realize instantaneous and large-capacity data transfer that is caused by the concurrence of data transfer between magnetic disks and which is not usually utilized, can be efficiently executed within its data transfer capability without providing memory and an internal bus, but still providing a large-capacity buffer for each magnetic disk. Simultaneously, the times for rotation re-synchronization, conducted to avoid the overlapped starts of a plurality of segments of data transfer in each magnetic disk, can be reduced and accordingly, the cost performance of the entire system can be improved.

What is claimed is:

1. A magnetic disk device composed of a plurality of magnetic disk drives, comprising:
a synchronizing unit synchronizing rotations of motors of the plurality of magnetic disk drives; and
a data storage unit shifting the data storage position of each magnetic disk in such a way that data can be read from each magnetic disk at different timings when the data is read from the magnetic disk; and storing the data, wherein
the buffer capacity of each magnetic disk drive is reduced by reducing the waiting time for reading data from each magnetic disk and also by preventing any excessive amount of data transfer for each time that the capacity of the data transmission line is exceeded.

2. The magnetic disk device according to claim 1, which uses a Serial ATA.

3. The magnetic disk device according to claim 1, wherein the synchronizing process further comprises a unit generating a synchronizing signal, and where this synchronizing unit establishes the synchronization by inserting the synchronizing signal between the data signals and then transferring these data signals with the synchronizing signal to each disk drive.

4. The magnetic disk device according to claim 1, wherein, if the data transmission line can transfer a plurality of segments of data from a plurality of magnetic disk drives at any one time, then the respective data storage positions, of the same number of magnetic disk drives as that of magnetic disk drives whose data can be transferred at any one time, are set to match their respective data reading timings.

5. The magnetic disk device according to claim 1, which uses a SCSI or an FC-AL.

6. A control method for a magnetic disk device with a plurality of magnetic disk drives, comprising:
synchronizing rotations of motors of the plurality of magnetic disk drives; and,
shifting the data storage position for each magnetic disk in such a way that data can be read from each magnetic disk at different timings when data is read from the magnetic disk and storing the data, wherein the buffer capacity of each magnetic disk drive is reduced by reducing the waiting time for reading data from each magnetic disk and preventing any excessive amount of data transfer at any particular time from exceeding the capacity of the data transmission line.

7. The magnetic disk device control method according to claim 6, wherein the magnetic disk device uses a Serial ATA.

8. The magnetic disk device control method according to claim 6, wherein the said synchronizing step further comprises:
generating a synchronizing signal, and where this synchronizing signal generation step establishes the synchronization by inserting the synchronizing signal between data signals and transferring the data signals with the synchronizing signal to each disk drive.

9. The magnetic disk device control method according to claim 6, wherein, if the data transmission line can transfer a plurality of segments of data from a plurality of magnetic disk drives at any one time, then the respective data storage positions, of the same number of magnetic disk drives as that of magnetic disk drives whose data can be transferred at any one time, are set to match their respective data reading timings.

10. The magnetic disk device control method according to claim 6, wherein the magnetic disk device uses a SCSI or an FC-AL.
